(19) United States
(12) Patent Application Publication
(10) Pub. No.: US 2015/0052040 A1
(43) Pub. Date: Feb. 19, 2015

(54) Transforming Debt Assets

(71) Applicant: Derrell J. Hendrix, East Molesey (GB)

(72) Inventor: Derrell J. Hendrix, East Molesey (GB)

(73) Assignee: RISCONSULTING GROUP LLC, THE, Boston, MA (US)

(21) Appl. No.: 13/968,516

(22) Filed: Aug. 16, 2013

(51) Int. Cl. G06Q 40/02

(52) U.S. Cl. CPC G06Q 40/025
USPC 705/38

(57) ABSTRACT

Techniques for transforming debt assets are disclosed. The techniques involve recording, by one or more computers, a transfer of a proprietary right in debt assets from a first party type to a legal trust, executing, by the one or more computers, a mathematical model to assess risks associated with the debt assets, determining, based on the assessed risk, terms for issuance of an obligation granting the first party type a right to use assets in the legal trust as collateral for one or more transactions, and recording, by the one or more computers, issuance of the obligation to the first party type. The first party type is a lender of the debt assets to a second party type. The obligation is issued in response to the transfer of the proprietary right in the debt assets.

This invention relates to financial services.

Financial institutions and related entities are typically regulated by governmental agencies to ensure that, among other things, the institutions and entities have sufficient capital, as well as sufficient collateral resources to support their investment activities. For example, certain types of United States (U.S.) insurance companies and reinsurance companies are required by the U.S. state insurance regulations to post a required amount of qualifying collateral in order to underwrite policies to their clients. Recently the United States passed Public Law 111-203 Jul. 21, 2010 short title “Dodd-Frank Wall Street Reform and Consumer Protection Act.” In addition, a global standard on banking commonly known as the “Basel Accords” and in particular “Basel III” introduced among other things new regulatory requirements on banking liquidity and leverage.

Qualifying collateral can be in various forms and can come from various sources. There is a global demand for qualifying collateral due to the changes in the global financial market and its regulations. For example, unsecured bank financing has become unavailable; derivatives have to satisfy new requirements on initial margin collateral; excess insurance reserves have increased globally; and tail risks are regulated and contingent capital is required.

### SUMMARY

Debt assets, which, as an example, can include loans or loan portfolios are transformed to provide qualifying collateral. In some situations, before being transformed, the debt assets may be unsuitable for use as collateral for certain transactions, e.g., due to the quality of the debt assets and the requirements for the collateral applied by various governmental agencies. However, the transformed debt assets may qualify as the collateral, with an improved quality and by satisfying the requirement of the collateral. The transformed debt assets can also be used for other purposes, such as enabling a bank issuing the security to finance its loan portfolio by entering into a securities loan or repurchase agreement with another financial institution.

According to an aspect of the invention, a computer-implemented method includes recording, by one or more computers, a transfer of a proprietary right in debt assets from a first party type to a legal trust, executing, by the one or more computers, a mathematical model to assess risks associated with the debt assets, determining, based on the assessed risk, terms for issuance of an obligation granting the first party type a right to use assets in the legal trust as collateral for one or more transactions, and recording, by the one or more computers, issuance of the obligation to the first party type. The first party type is a lender of the debt assets to a second party type. The obligation is issued in response to the transfer of the proprietary right in the debt assets.

According to an additional aspect of the invention, a computer program product tangibly embodied on a computer readable storage device includes instructions to record, by one or more computers, a transfer of a proprietary right in debt assets from a first party type to a legal trust, execute, by the one or more computers, a mathematical model to assess risks associated with the debt assets, determine, based on the assessed risk, terms for issuance of an obligation granting the first party type a right to use assets in the legal trust as collateral for one or more transactions, and record, by the one or more computers, issuance of the obligation to the first party type. The first party type is a lender of the debt assets to a second party type. The obligation is issued in response to the transfer of the proprietary right in the debt assets.

According to an additional aspect of the invention, a system includes one or more computer system, each system including a processor and memory coupled to the processor, and the computer system is configured to record, by one or more computers, a transfer of a proprietary right in debt assets from a first party type to a legal trust, execute, by the one or more computers, a mathematical model to assess risks associated with the debt assets, determine, based on the assessed risk, terms for issuance of an obligation granting the first party type a right to use assets in the legal trust as collateral for one or more transactions, and record, by the one or more computers, issuance of the obligation to the first party type. The first party type is a lender of the debt assets to a second party type. The obligation is issued in response to the transfer of the proprietary right in the debt assets.

Implementations may include one or more of the following features.

The transfer is one of a plurality of transfers from plural ones of the first party type and the method further comprises recording the plurality of transfers into corresponding plural accounts for the plural ones of the first party type. The debt assets are long term loans, short term loans and accounts receivables. A guarantee is recorded by the one or more computers. The first party type guarantees to margin the debt assets. The margin is other types of financial assets that can include cash or securities. The proprietary right in the debt assets is acquired through a lending agreement. The obligation has a predetermined maturity date, and the method further comprises recording, by the one or more computers, a guarantee by the first party type to return the obligation or pay cash based on the value of the obligation on the predetermined maturity date. The proprietary right is legal title to the debt assets without a transfer of a right to collect interest from the second party. A guarantee is recorded by the one or more computers. The first party type guarantees to buy the transferred debt assets back on a maturity date of the obligation. The proprietary right is transferred through transferring an entire ownership of the debt assets and the method further comprises transferring interest on the debt assets from the legal trust to the first party type. The interest is equal to the actual return on the debt assets plus an additional amount of interest on the obligation issued to the first party type tied to a generally accepted interest rate reference plus an additional interest amount. A guarantee is recorded by the one or more computers. The first party type guarantees to buy the transferred debt assets back on a maturity date of the obligation. The first party type receives cash for transferring the debt assets and pays cash for buying the transferred debt assets back and the method further comprises recording, by the one or more computers, receipt of cash from the first party type in response to the issuance of the obligation. The debt assets further comprise an enhanced credit contract. A substitution of the debt assets with other debt assets from the first party type is recorded by the one or more computers. The debt assets provided by the legal trust can be used as collateral for one or more transactions with a second party.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram showing a securitization system for debt assets.

FIG. 2 is a flow diagram showing an example process of entering an agreement.

FIGS. 3A-3C are block diagrams showing transaction flows in an exemplary repurchase agreement.

FIGS. 4A-4C are block diagrams showing transaction flows in an exemplary sale agreement.

FIG. 5 is a block diagram of an example system including multiple party systems.

FIG. 6A-6D are block diagrams of example uses of obligations.

FIG. 7 is a block diagram of an exemplary computer system.

### DETAILED DESCRIPTION

A legal trust is established to transform debt assets into assets that are eligible as collaterals for other transactions. For example, the debt assets are transformed into marketable securities, e.g., exchange-traded cleared securities. Financial segments, e.g., banks, insurers, and others, can access the legal trust through a platform to use the transformed debt assets as collaterals for their own transactions, or to supply collateral to other clients of theirs. As an example, one of the financial segments can be another legal trust that issues obligations on behalf of parties who need collaterals to back up their transactions. An example of the other legal trust is the legal trust described in U.S. Pat. No. 7,769,655 and U.S. Ser. No. 13/693,120, filed Dec. 4, 2012, and U.S. Ser. No. 13/693,131, also filed Dec. 4, 2013, the contents of these patent and patent applications are incorporated herein by reference in their entirety. The other legal trust may also have other forms or other features.

The debt assets can have various forms, for example, loans or loan portfolios, long term loans, short term loans, or accounts receivables. The debt assets can be held by banks or other parties. These parties form agreements with the legal trust to transform the debt assets they own. A variety of agreements and other mechanisms can be implemented to perform the transformation. Examples of lending agreements, repurchase agreements, and sale agreements that are suitable for use in transforming the debt assets are described below.

### Lending Agreements

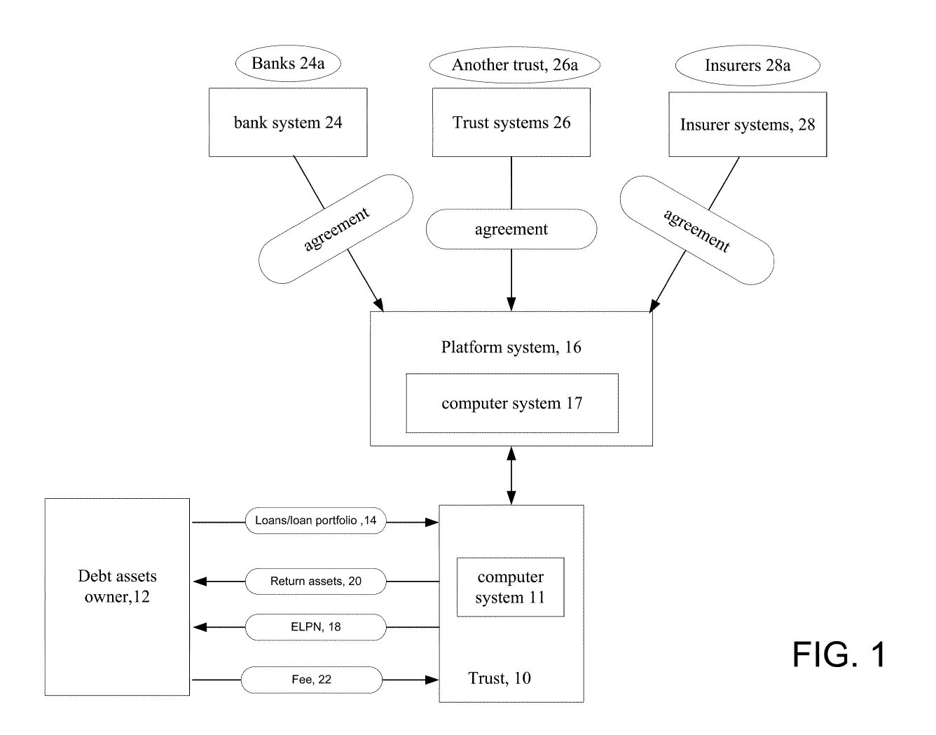

Referring to FIG. 1, a system to transform debt assets into marketable securities, e.g., exchange-traded cleared securities includes a legal trust 10, such as a series “Delaware Statutory Trust,” and which includes a computer system 11, that enters into a lending agreement with market participants, e.g., a bank 24a, an insurer 28a, another legal trust 26a, and an owner 12a of debt assets. Transactions between the legal trust 10 and the market participants occur by computer system 11 and via respective market participant systems such as a bank system 24, an insurer system 28, another legal trust system 26, an owner system 12 of debt assets, etc. For simplicity of the discussion, sometimes the same numerical references are used for the participant systems and the respective participants. For example, the owner may be referred to as owner 12 and the owner system may also referred to as owner system 12. The lending agreements borrow debt assets from these participants and issue obligations to these participants for their transactions. Also for simplicity of the discussion, the different market participants may be referred to as debt assets owners. Each agreement can be reached independent of the other agreements.

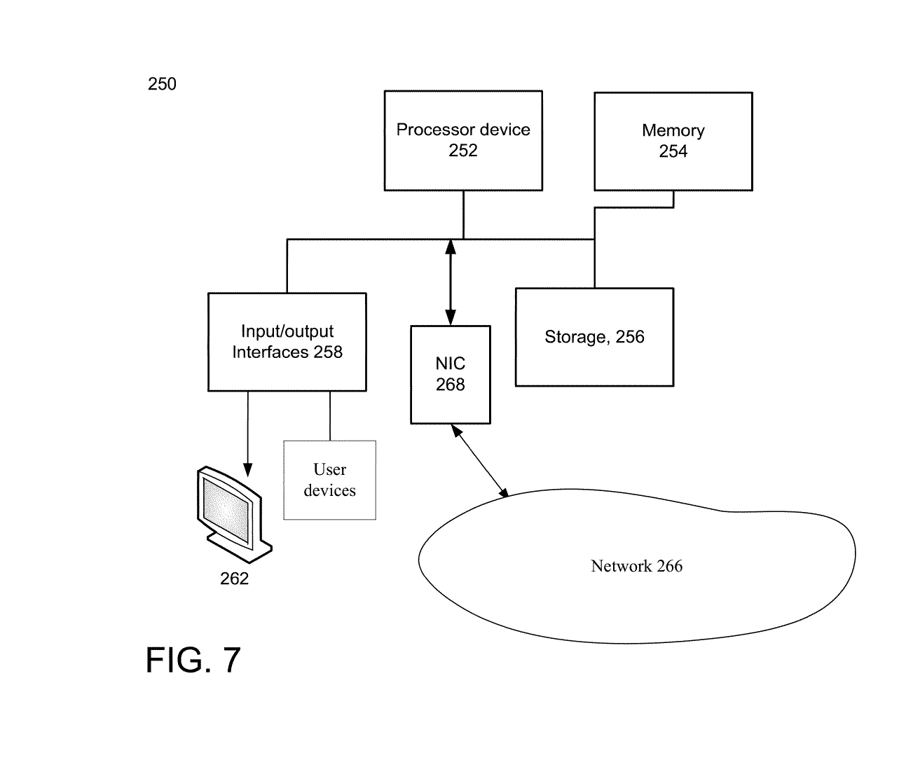

The agreements are reached through an intermediary platform 16 (platform 16) that includes a computer system 17 and which provides an interface to the debt assets owner 12a to interact with the system 11. The platform 16 as well as the system 11 and the systems 12, 24, 26, and 28 include computer systems (see FIG. 7), that provide user interfaces (not shown) for access by an administrator. The market participant systems 12, 24, 26, 28, the platform 16, and the system 11 are connected through a network, e.g., a computer network, the Internet, a phone network, or a combination of these networks.

A first embodiment involves a lending agreement between the debt assets owner 12 and the trust 10. Under the lending agreement, the legal trust borrows debt assets, such as loans and receivables, or a loans/loan portfolios 14 in the example shown in the figure, from the owner 12. Typically, to consummate this borrowing the system 11 has the borrowed debt assets recorded as a borrowed asset on the legal trust accounting system and the owner system 12 has the debt assets recorded as a lent asset on the owner accounting system. The legal trust system and the various processes involving the system can be managed electronically, e.g., through one or more computer systems.

In some implementations, the borrowed debt assets are deposited into a series account (not shown) designated to the owner 12 and within the legal trust 10. Although only one owner 12 is shown in the figure, the legal trust 10 can enter into lending agreements with multiple owners, simultaneously and/or at different times. Each owner may have its own corresponding series account segregated from the other owners' series accounts. The different accounts for different owners can facilitate operations of the lending agreements. However, other arrangements of the accounts can also be made.

Under the lending agreement, the legal trust 10 obtains a proprietary right in the debt assets owned by the owner 12 to allow the legal trust 10 to use the debt assets as collateral. An example of the proprietary right is a perfected security interest. In exchange for lending the debt assets to the legal trust 10, the owner 12 receives an obligation, e.g., a collateral note, from the legal trust 10 for use in other transactions the owner may enter with other parties (not shown). The obligation or collateral note issued by the legal trust 10 to the owner 12 refers to assets of the legal trust 10 as collateral assets. The collateral assets can typically have a rating higher than the debt assets owned by the owner 12 and can be more suitable for use as collateral than those debt assets (explained below).

An example of the obligation or collateral note is an enhanced debt asset portfolio note here referred to as an enhanced loan portfolio note (ELPN) 18 issued by the legal trust. The ELPN 18 is associated with, i.e., is backed by the debt assets deposited in the corresponding series account of the owner 12. The ELPN in addition to the debt assets includes one or more credit enhancement contracts. In some implementations, the credit enhancement contract can be the lending agreement having certain credit enhancement provisions. Other implementations for example not involving a Delaware Series Trust scenario may be feasible.

In addition to lending the debt assets to the legal trust, the owner 12 may be required to pay a fee 22 to the legal trust for the obligation received from the legal trust 10. The fee 22 can be a one-time up-front fee, or can be periodic payments, or both, and the amount of the fee 22 can be based on the amount of collateral assets referenced by the obligation. As an example, the fee is 3 months London Interbank Offered Rate (LIBOR) plus a market spread (e.g., an annual percentage fee).

Generally, the lending agreement has a termination date (which can also be called the maturity date), at which the trust 10 returns (20) the borrowed debt assets to the owner 12, and the owner 12 returns the obligation to the trust 10. The termination date can be a predetermined date agreed upon by the legal trust and the owner. The termination may also occur under other circumstances before the predetermined maturity date, e.g., triggered by when terms specified in the lending agreement are satisfied. To return the obligation, the owner can return all the collateral assets withdrawn (if any, as discussed below), or pay cash in an amount equal to the face amount of the non-returned obligation.

In some implementations, the owner 12 can substitute the deposited debt assets based on criteria set out in the lending agreement. Examples of the criteria include maintaining quality of the debt assets at a desired level, limiting concentration of loan portfolio(s), and ensuring that the legal trust has a proprietary interest in the replacement debt assets. With the permitted debt assets replacement, the owner 12 can keep the issued obligation (e.g., avoid termination) when the value of the initially deposited debt assets drop below a predetermined threshold, e.g., specified by the lending agreement.

In some implementations, the owner 12 may be required under the agreement to substitute or replace those debt assets that are paid back before the termination of the agreement. Generally, the owner 12 collects the principal of the debt assets when a lender pays back. The replacement of those debt assets can be other debt assets or securities so that the value of the debt assets in which the trust 10 has a proprietary interest is maintained. Alternatively, when some of the debt assets are paid back to the owner 12 when the agreement is effective, the owner 12 may return the originally issued obligations to the trust 10 and the trust 10 may re-issue new obligations (e.g., having a reduced face amount) based on the assessed debt asset values that remain with the trust 10.

The trust 10 may be exposed to various types of risks during the term of the lending agreement. For example, the assets in the legal trust 10 that are associated with the collateral issued to the debt assets owner 12 can be withdrawn by a third party who is under transaction agreements with the assets owner 12. In an example, the withdrawal takes place when the owner 12 defaults under a transaction agreement. To compensate the withdrawal, the legal trust 10 may retain a corresponding amount of debt assets without returning that amount to the owner 12 at the termination. In some situations, whether the legal trust 10 is properly compensated for the withdrawn assets depends on the value of the debt assets deposited by the owner and the amount of the withdrawal. Sometimes the value of the debt assets is not be sufficient to compensate the withdrawal and the debt assets owner 12 is required to compensate the legal trust. The legal trust 10 faces the risk of the assets owner 12 defaulting under this circumstance.

To reduce the risks, the legal trust may require the owner to guarantee that the owner will pay the legal trust the difference between the withdrawn amount and the total deposited debt assets. In some implementations, during the time the lending agreement is in effect, the owner 12 is obliged to margin the borrowed debt assets to maintain a total value equal to the face amount of assets that the obligation, e.g., the ELPN 18, references. Such a margining requirement allows the trust to recover the entire amount of assets withdrawn by the third party by retaining the debt assets and reduces the risks faced by the legal trust. The margining may be required at all times when the lending agreement is effective. In other situations, the margining is required only at certain times, e.g., when the value of the deposited debt assets drops below a predetermined threshold or below a certain percentage of the collateral assets referenced by the issued obligation. The owner may be required to margin the collateral daily, weekly, monthly, or at other periodic cycles.

Enforcing the risk reduction mechanisms under the lending agreement, which may include receiving guarantees from the owner to margin the deposited assets and return the collateral assets in full or in cash equivalent at maturity, can effectively enhance the rating of the ELPN to be at least equal to the owner's rating, which can be higher than the rating of the debt assets owned by the owner. In some implementations, to provide collateral assets with a good rating, the legal trust chooses owners who have a rating of A− or higher to enter into the lending agreement.

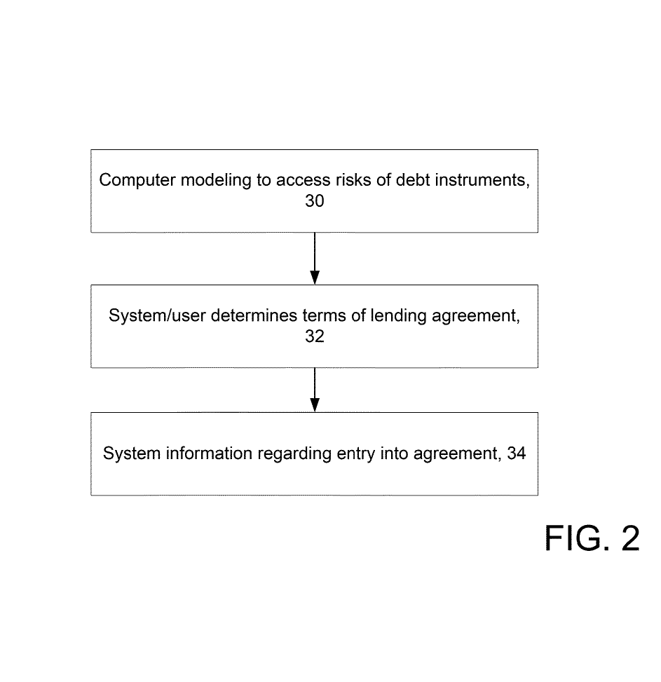

Referring also to FIG. 2, in some implementations, to form a lending agreement, the system 11 includes a computer implemented process that assesses (30) risks associated with the debt assets. This assessment of risk is used for determining the terms of the lending agreement. The assessment is executed on a computer using mathematical (e.g., statistical) models that return values corresponding to a predicted risk of default and so forth. Examples of risks include debtor default (or the collectability of the debt, missing of interest payments, and so forth). Based on the assessed risks, the legal trust determines (32) the terms for the lending agreement to be entered into with the owner 12. The terms can specify the amount of collateral the legal trust 10 issues to the owner, the fee 22, the termination date, and other factors.

In some situations, the amount of the collateral and/or the risks associated with the debt assets can be valued using a valuation model typically computer executed by a valuation provider service acceptable to the legal trust and the owner, and in some implementations to the administrator of the platform 16. After the determined terms are agreed upon by the owner, the legal trust enters (34) into the lending agreement by having entries made in each of the affected accounting systems of the legal trust, owner and administrator systems.

The agreements between the other market participants 24, 26, 28 and the legal trust 10 can be similarly formed. Each agreement can be specifically tailored based on the need of the participant and the risks associated with the agreement.

### Repurchase Agreements

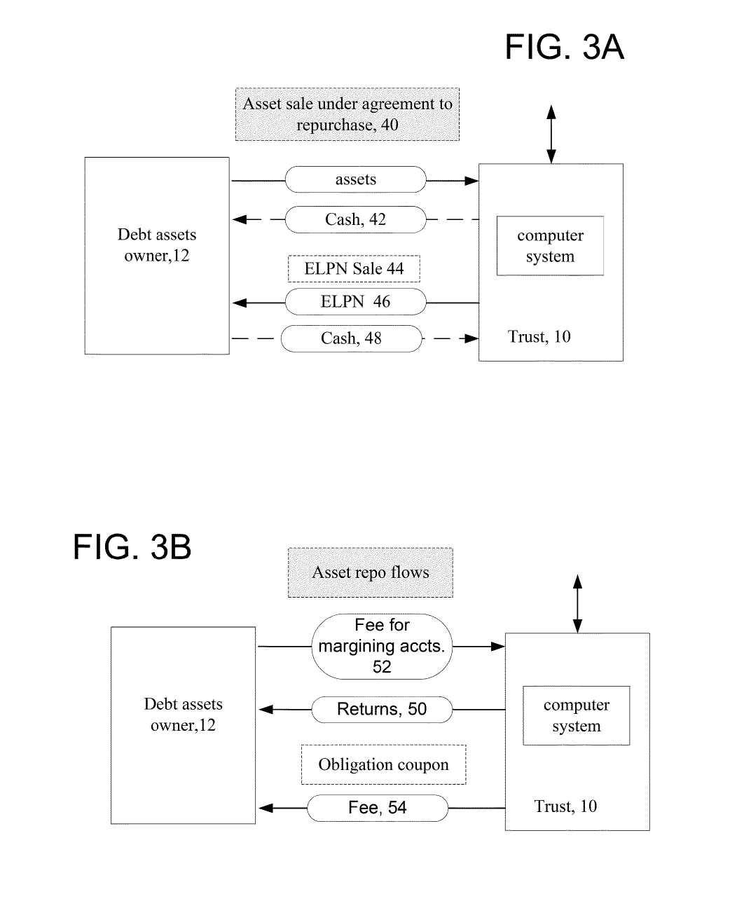

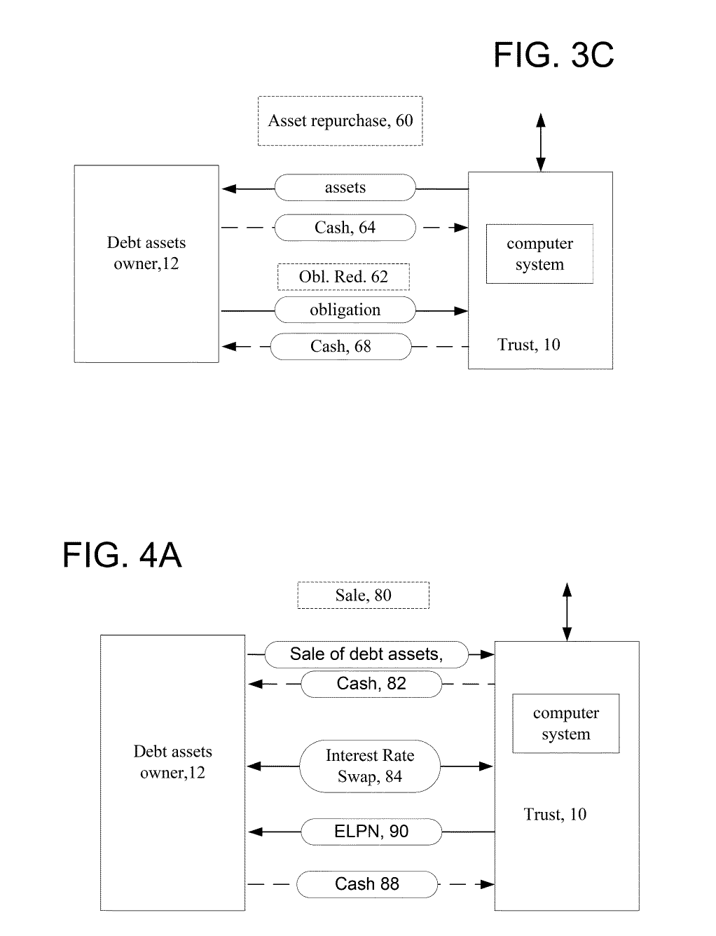

Referring to FIGS. 3A-3C, instead of a lending agreement, the parties of FIG. 1 can enter into repurchase agreements to allow the legal trust 10 to obtain rights to debt assets owned by the parties and issue obligations to the parties for the parties to use as collateral for other transactions. Features discussed for the lending agreements are all applicable for the repurchase agreements, except for those conflicting with the details of the repurchase agreements discussed below. For example, the risk assessment and the valuation of the debt assets and/or the obligation are performed similarly to those performed in forming the repurchase agreement as shown in FIG. 2.

Referring particularly to FIG. 3A, to carry out the repurchase agreement between the owner 12 and the trust 10, initially, the owner 12 sells the debt asset for cash 42 to the legal trust in an asset sale 40. Under the terms of the sale 40, the owner agrees to buy back the debt assets at a predetermined date agreed upon by the owner 12 and the trust 10 (and/or the administrator of the platform 16 shown in FIG. 1). Simultaneously with or in response to the asset sale 40, the legal trust sells an obligation, in this example, an ELPN 46, to the debt assets owner 12 for cash 48 in an obligation sale 44. In some implementations, the terms of the obligation sale 44 match the terms of the asset sale 40. For example, the legal trust 10 is obligated to buy the obligation back at the same predetermined date when the debt assets owner 12 buys back the assets. The asset sale 40 and the obligation sale 44 also contain other terms, e.g., terms that specify required actions of the assets owner 12 and the legal trust 10 when the repurchase agreement is in effect (see, e.g., FIG. 3B).

The obligation 46 (in this example, the ELPN) has similar or the same features as the obligation 18 of FIG. 1. The repurchase agreement and the processes of carrying out the agreement securitize the debt assets. For example, under the agreement, the rating of the debt assets is at least the same as the rating of the debt assets owner. In some situations, the legal trust 10 can choose to deal with debt assets owners who have a rating of A− or higher, so that the rating of the debt assets is A− or higher. Similar to the discussion made in connection with FIG. 1, the obligation received or purchased by the owner 12 can be used as collateral for other transactions the owner is interested in entering. Also, the value and risks associated with the purchased debt assets and the obligation 46 are evaluated, e.g., using a method or another party (or agency) agreed upon by both the owner 12 and the legal trust 10.

Referring to FIG. 3B, after the sales 40, 44 and during the time the repurchase agreement is in effect, the trust 10 pays the owner 12 any returns on the purchased debt assets, such as interest paid by a party who took a loan from the debt assets owner 12. Effectively, the debt assets owner 12 continues to earn returns on the debt assets. The debt assets owner 12 pays a fee 52 to the trust 10, e.g., similar to the fee 22 of FIG. 1, which may include the LIBOR plus a market spread (e.g., an annual percentage fee). The debt assets owner 12 may also be required to margin the debt assets sold to the trust 10, e.g., periodically (such as daily or monthly) or at predetermined times. The margining may be done in a similar way as discussed with respect to the lending agreement. Furthermore, the trust pays a fee 54 to the debt assets owner, which may also include the LIBOR plus a market spread, similar to the fee 22 or the fee 52. In some implementations, the fees 52, 54 are round-trip of cash.

Referring to FIG. 3C, when the repurchase agreement terminates (or reaches maturity), an asset repurchase 60 and an obligation redemption 62 are carried out between the debt assets owner 12 and the trust 10. In the asset repurchase 60, the debt assets owner 12 repurchases, using cash 64, the debt assets that were initially sold to the trust 10. Simultaneously or at a later time, in the obligation redemption 62, the debt assets owner 12 returns the previously purchased obligation to the trust 10 in exchange for cash 68.

Referring back to FIGS. 3A and 3B, in some implementations, the cash flow in sales 40, 44, the repurchase 60, and the redemption 62 may be representative or notional, instead of being physical. For example, instead of physical cash, a note may be used. In some situations, in actual cash amount, the cash 42 is the same as the cash 64, and the cash 48 is the same as the cash 68. Accordingly, the trust 10 and the owner 12 may choose to transfer nothing when the agreement requires a “cash” transfer. In these and other figures, transfers that can be non-physical are shown in dash lines, and transfers that are physical are shown in solid lines.

The repurchase agreement and the sale agreement have many similarities. In some implementations, the debt assets owner 12 is paid in different forms in these two different agreements.

### Sale Agreements

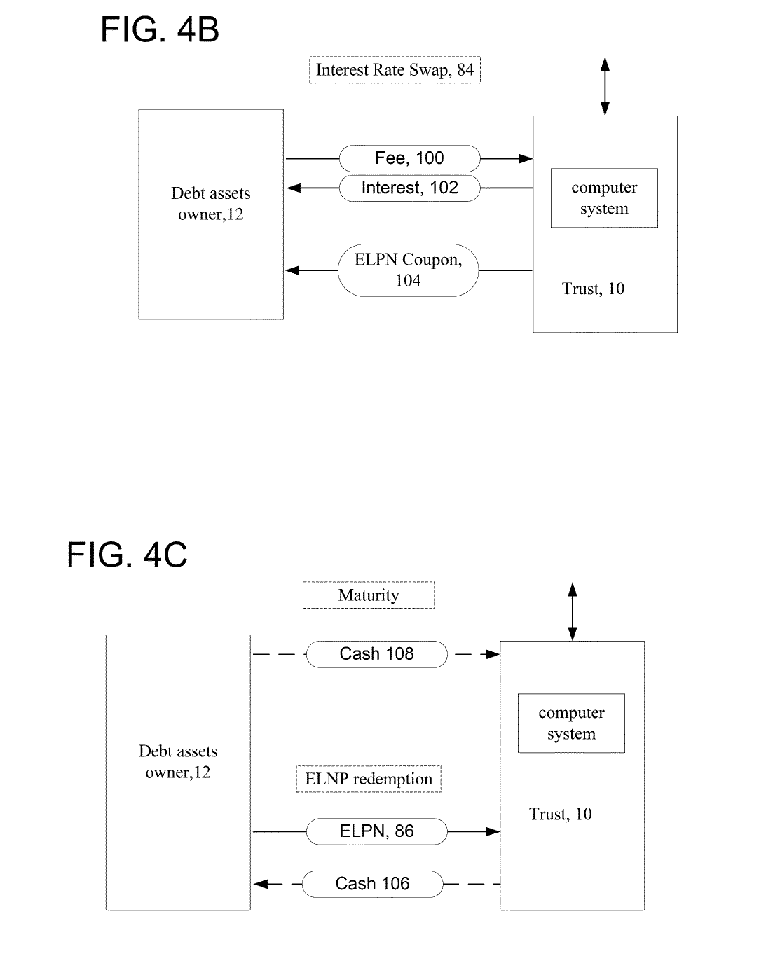

Referring to FIGS. 4A-4C, alternative to a lending agreement or a repurchase agreement, the parties of FIG. 1 can enter sale agreements to allow the legal trust 10 to obtain rights to debt assets owned by the parties and issue obligations to the parties for the parties to use as collateral for other transactions. Features discussed for the lending agreements and the repurchase agreement are all applicable for the repurchase agreements, except for those conflicting with the details of the sale agreements discussed below.

Referring particularly to FIG. 4A, under a sale agreement between the debt assets owner 12 and the trust 10, the debt assets owner 12 sells debt assets to the trust 10 for cash 82 in a sale 80. The term of the sale 80 includes that the debt assets owner 12 has the obligation to buy the debt assets back at a predetermined date. Simultaneously to or at a different time, e.g., after the sale 80, the trust 10 sells an interest rate swap 84 to the debt assets owner 12. The interest rate swap 84 can be a fixed or a floating interest rate swap, or a combination of them. Under the interest rate swap 84, the trust 10 pays the actual return on the debt assets for LIBOR and a fee predetermined by the trust 10 and the debt assets owner 12, e.g., similar to the fee 22 discussed previously.

In addition to the sale 80 and the interest rate swap 84, under the sale agreement, the trust 10 sells obligations, e.g., an ELPN 86, as shown in the figure, to the debt assets owner 12 for cash 88 in an obligation sale 90. The obligation sale 90 can have similar features to the obligation sale discussed for the repurchase agreement. For example, the term of the sale 90 may include that the trust 10 is obligated to pay a fee, e.g., LIBOR plus a market spread, to the debt assets owner 12.

Referring to FIG. 4B, after entering the sale agreement discussed with respect to FIG. 4A, an example of the cash flow between the debt assets owner 12 and the trust 10 is as follows. The interest rate swap cash flows by the debt assets owner 12 paying a fee 100, which may include LIBOR plus a margin, while the trust 10 paying returns on the debt assets purchased from the debt assets owner 12, such as interest on loans, to the debt assets owner 12. The obligation cash, or in this example, the ELPN cash, flows by the trust 10 paying a fee 104, which may include LIBOR plus a predetermined rate on the ELPN, to the debt assets owner 12.

Referring to FIG. 4C, when the sale agreement terminates or matures, the debt assets owner 12 returns the obligation, which is the ELPN 86 in this example, to the trust 10 for cash 106. Simultaneously or at a different time, the debt assets owner 12 buys the previously sold debt assets back from the trust 10 using cash 108.

Similar to the cash flows discussed with respect to FIGS. 3A-3C, the cash flow in FIGS. 4A-4C may involve non-physical transfers or effectively no transfers, instead of including physical cash transfers.

### Example Implementations

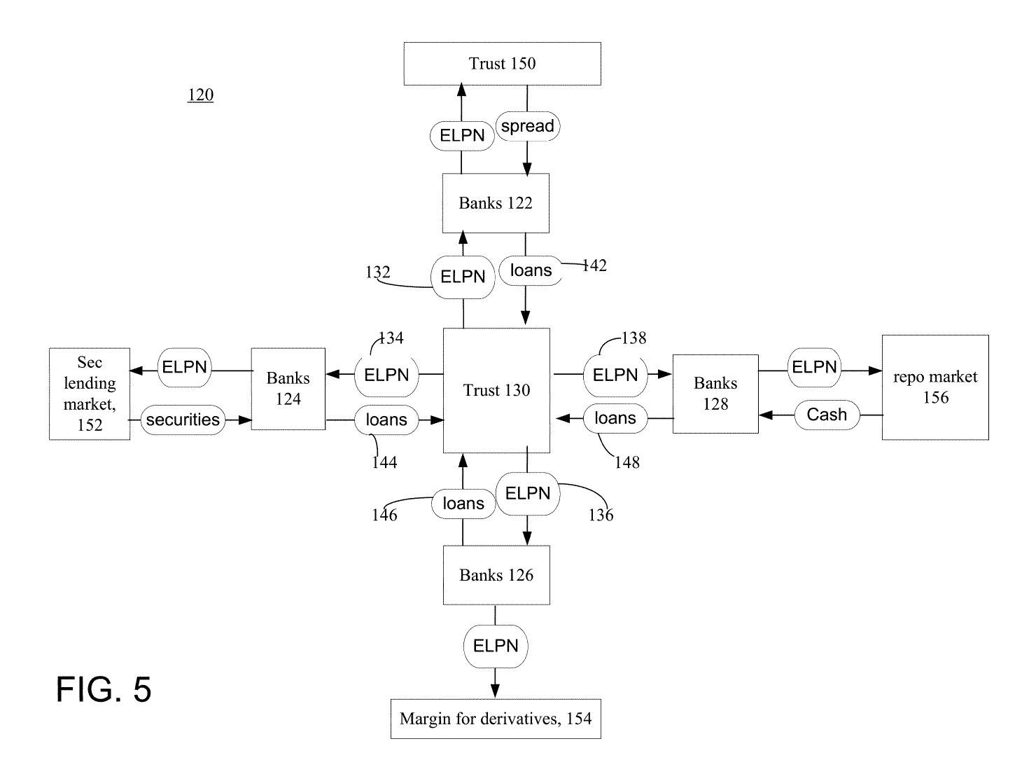

The agreements discussed can be used in securitizing debt assets and improving the rating of the debt assets. One example use of the securitized debt assets includes providing collateral based on the securitized debt assets to facilitate transactions. FIG. 5 shows an example of different party types that can participate in and benefit from the agreements and the related processes. For the purpose of discussion, loans are discussed as a specific example. The techniques described can be applied to other suitable types of debt assets, with possible modifications associated with the type of the debt assets. Similarly, in this example, banks are described as examples of debt assets owners and the ELPN as an example of obligations.

In the example system 120, one or more of banks 122, 124, 126, 128 enters into agreements with a trust 130 to transfer a proprietary right in one or more of loans 142, 144, 146, 148 to the trust 30 in exchange for ELPNs 132, 134, 136, 138, respectively. The proprietary right can be based on borrowing or obtaining legal title or other types of the rights in the loans. The right can vary based on the type of agreement entered into between a bank and the trust 130.

The banks use the ELPNs as collateral in other transactions. For example, the bank 122 lends the ELPN to another trust 150, which in turn uses the ELPN to back issuance of collateral notes on behalf of one or more clients. In some situations, one of the clients is the bank 122. The trust 150 can have the same or similar features as the trust discussed in U.S. Ser. No. 13/693,120, the entire content of which is incorporated herein by reference. The bank 124 enters another example transaction with a security lending market 152. The security lending market 152 can be unregulated and may only represent the existence of lending/borrowing relationship between a lender and a borrower without necessarily being in the form of a formal market. The bank 124 lends the ELPN to one or more lenders of the market 152 in exchange for high quality securities, e.g., rated A− and above. The loans 144 initially owned by the bank 124 may have a relatively low rating, e.g., being below A−. Through the ELPN, the bank 124 effectively replaces the loans 144 with highly rated securities that can meet collateral requirements that the loans 144 may not have been able to meet. In another example, the bank 126 uses the ELPN as collateral for derivatives, e.g., for margining the derivatives. Exemplary derivatives include interest rate swaps. Again, the loans 146 originally owned by the bank 126 may not be qualified for such use, and the transformation of the loans 146 into the ELPN enables the loans 146 to be indirectly used in derivatives. The ELPN can also be sold for cash financing. For example, the bank 128 sells the ELPN to a repurchase market 156 for cash.

Although four example banks are shown, and four example uses of the ELPN are discussed, there can be many other banks (or parties) and many other uses.

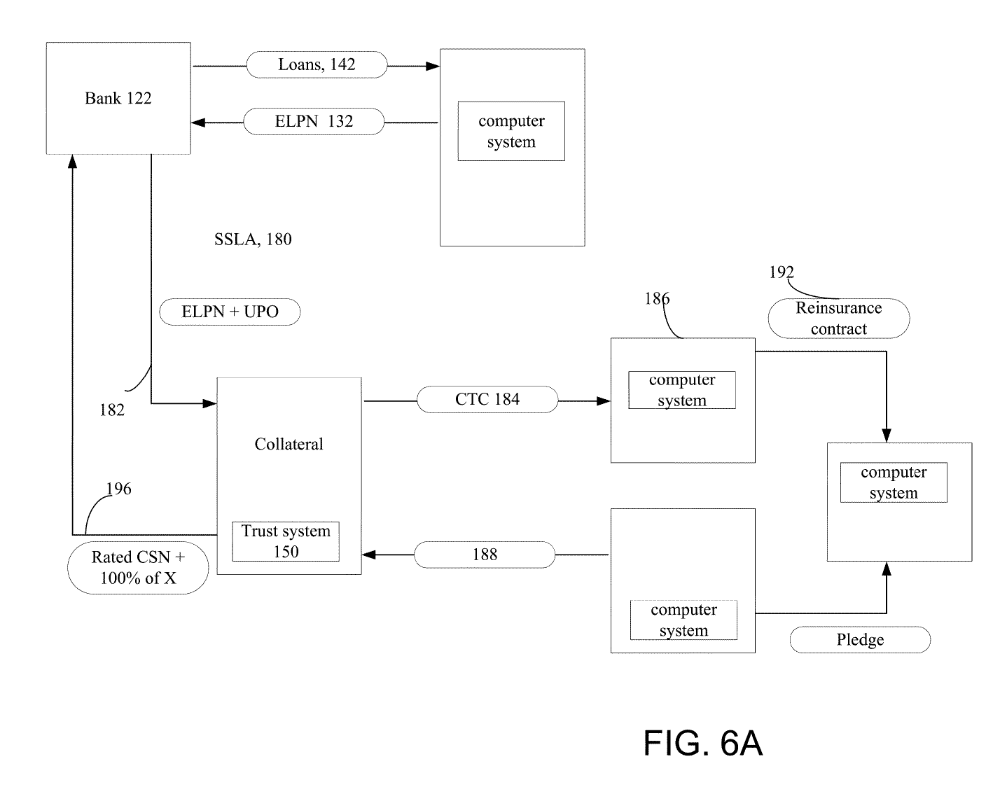

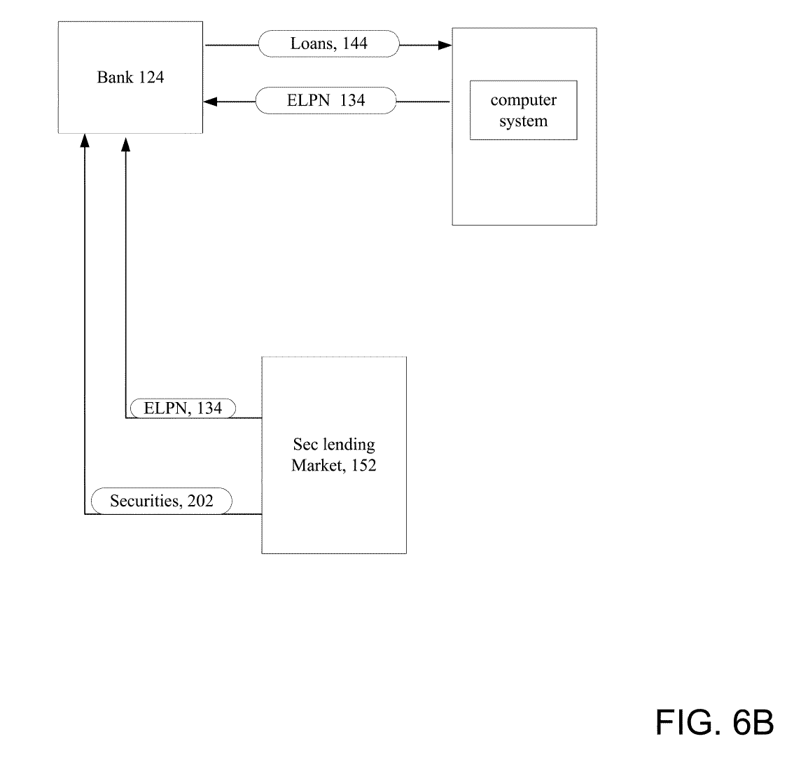

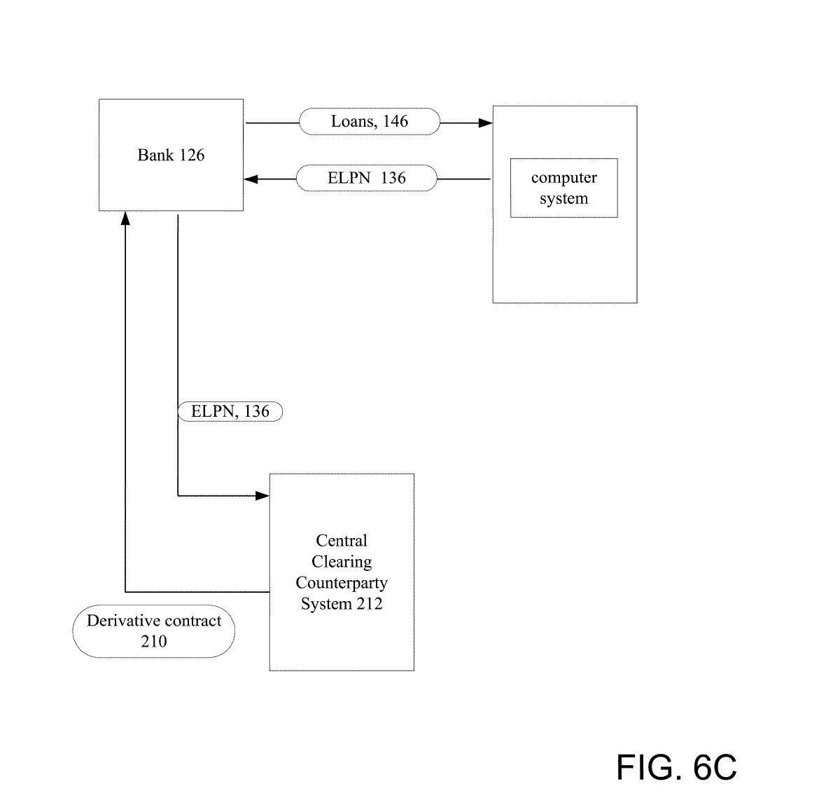

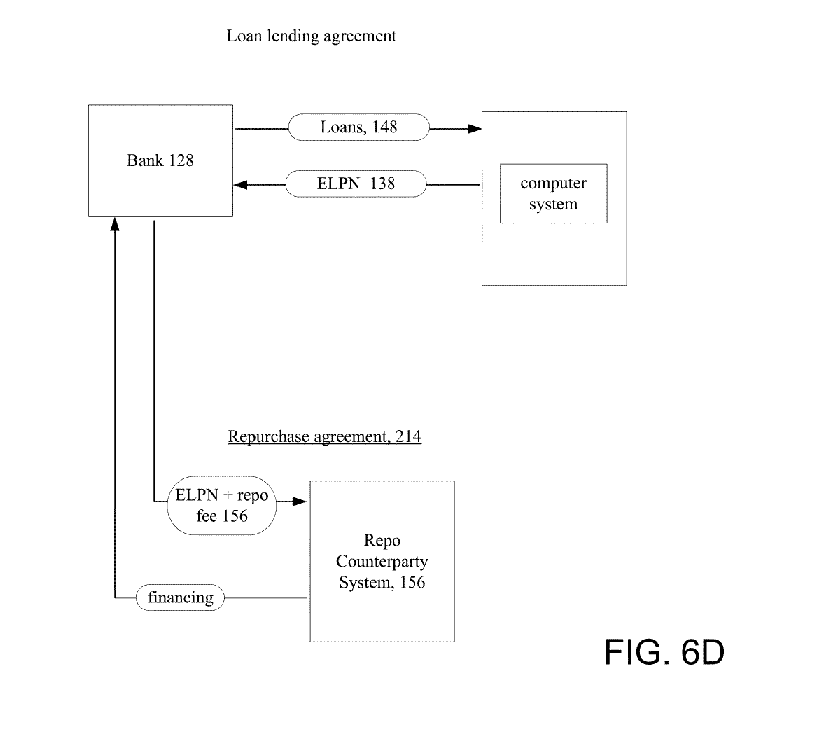

Referring to FIGS. 6A-6D, details of the examples of the ELPN uses discussed with respect to FIG. 5 are shown. For the purpose of the discussion assume that the banks 122, 124, 126, 128 form lending agreements with the trust 130. All other agreements are similarly applicable.

Referring in particular to FIG. 6A, the bank 122 forms lending agreements with the trust 130 (loans 142 in exchange for ELPN 132). The bank 122 enters into structured securities lending agreement (or SSLA) 180 with the other trust 150 to use the ELPN to generate revenue. Under the SSLA 180, the bank 122 delivers the ELPN 132 to the trust 150 and provides an unconditional payment obligations (UPO) 182, e.g., in the form of a letter of credit, credit default swap, or a liquidity obligation issued by one or more UPO providers rated A− or better. In return, the trust 150 pays an SSLA fee and a UPO fee to the UPO provider, e.g., a UPO bank. The term of the SSLA 180 may also specify that the ELPN 132 and the UPO 182 deposited in the trust 150 are only drawable from the trust when a client 186 of the trust defaults. In this example, the client 186 is a reinsurer who enters collateral transaction contracts 184 with the trust 150 such that the trust issues collateral 188, e.g., collateral notes, for the client 186 to reinsure a beneficiary 190 under a reinsurance contract 192. In some situations, the collateral 188 issued for the client 186 is placed in a beneficiary trust 194. The beneficiary 190 has access to the beneficiary trust 194 when the client 186 defaults on the reinsurance contract 192. In some implementations, the bank 122 is a client of the trust 150. The trust 150 can provide collateral to the bank 122 in the form of a collateral support note (CSN) 196. The CSN can be another form of a rated security that is different from the ELPN. For example, the trust system 150 may issue a CSN 196 to enable a provider of collateral to trust system 150 to finance that collateral by entering into a securities lending or repurchase agreement with another financial institution.

By securitizing the loans 142 using the methods, systems, and mechanisms discussed in the present disclosure and further entering into tractions with the trust 150, the bank is exposed to low probability, double trigger risk. For example, the risk may originate from situations in which the underlying insurance business of the beneficiary 190 performs worse than expected, such that the reinsurance is payable under the reinsurance contract 192, and the reinsurer 182 defaults under the reinsurance contract 192. The bank 122 receives income as a percentage of the value of ELPN. This percentage can vary between a relatively small amount of a few tenths of a percent upward to a few percent, and would in any event be market based. The trust 150 can use the ELPN to serve multiple, different types of clients.

Referring to FIG. 6B, the bank 124 forms lending agreements with the trust 130 (loans 144 in exchange for ELPN 134). The bank 124 enters into a securities lending agreement 202 with the security lending market 152 to borrow high quality securities, e.g., rated A− and above from the security lending market 152 using the ELPN 134 as collateral. The security lending market 152 can have multiple participating lenders and borrowers (neither shown in the figure) and can be local, distributed, national or international. In some implementations, the bank 124 delivers the ELPN 134 to a lender and in return receives securities, e.g., Government bonds, from the lender. The bank 122 can pay the lender a fee as compensation for the securities.

Referring to FIG. 6C, the bank 126 forms lending agreements with the trust 130 (loans 146 in exchange for ELPN 136). The ELPN 136 can allow the bank 126 to transform the loans 146 into collateral for supporting its derivatives activities. For example, in the course of its normal business, the bank 126 enters into an over-the-counter (OTC) derivatives contract 210 via a central clearing counterparty (CCP) 212. Generally, the OTC derivatives contract 210 is secured with acceptable collateral to support initial and variation margin requirements. The loans 146 may not be qualified as acceptable collateral, e.g., when their rating is below A−. However, the ELPN 136 can have a higher rating than the loans 146 (as explained previously), and the bank 126 can deliver the ELPN 136 as the derivatives collateral to the CCP 212.

Referring to FIG. 6D, the bank 128 forms lending agreements with the trust 130 (loans 148 in exchange for ELPN 138). The bank 128 enters into a repurchase agreement 214 with the repurchase counterparty 156 and delivers the ELPN 138 for bank financing, e.g., by receiving cash in return. In particular, the ELPN can be a rated note with recourse to the bank 128. For example, a rated instrument is formed from unrated loans through the loan transformation based on the loan lending agreement. During the term of the repurchase agreement, the bank 128 continues to collect the income on the underlying loans and pays a fee, e.g., the repurchase fee to the repurchase counterparty 156.

Elements of different agreements or implementations described herein may be combined to form other implementations not specifically set forth. Elements may be left out of the processes, systems, apparatus, etc., described herein without adversely affecting their operation. Various separate elements may be combined into one or more individual elements to perform the functions described herein.

Although specific examples of the lending agreement, the repurchase agreement, and the sale agreement are discussed, the example terms discussed for these agreements may be altered to fit specific needs of the parties.

FIG. 7 is a schematic diagram of an example computer system 250. The system 250 can be used for practicing operations of the legal trust (such as the legal trust 10 of FIG. 1) and the platform (such as the platform 16) described above as well as the market participant, e.g., bank systems 24, insurer systems 28, another legal trust system 26, and an owner system 12. For example, one or more parts or one or more mechanisms/functions of the legal trust and/or the platform can reside and be executed on the computer system 250. The system 250 can include a processor device 252, a memory 254, a storage device 256, and input/output interfaces 358 interconnected via a bus 260. The processor 252 is capable of processing instructions within the system 250. These instructions can implement one or more aspects of the systems, components and techniques described above. In some implementations, the processor 252 is a single-threaded processor. In other implementations, the processor 252 is a multi-threaded processor. The processor 252 can include multiple processing cores and is capable of processing instructions stored in the memory 254 or on the storage device 254 to display graphical information for a user interface on output monitor device 262.

The computer system 250 can be connected to a network 266, e.g., the Internet, through a network interface controller 268. Other systems, such as the client systems, the counterparty systems, the bank systems, etc. discussed above can also be connected to the same network or a different network that can communicate with the network.

The memory 254 is a computer readable medium such as volatile or non-volatile that stores information within the system 250. The memory 254 can store processes related to the functionality of the valuation system or valuation platform, for example. The storage device 256 is capable of providing persistent storage for the system 250. The storage device 256 can include a floppy disk device, a hard disk device, an optical disk device, or a tape device, or other suitable persistent storage mediums. The storage device 256 can store the various databases described above. The input/output device 258 provides input/output operations for the system 250. The input/output device 258 can include a keyboard, a pointing device, and a display unit for displaying graphical user interfaces.

An exemplary view of a computer system is shown in FIG. 7, and is but one example. In general, embodiments of the subject matter and the functional operations described in this specification can be implemented in digital electronic circuitry, or in computer software, firmware, or hardware. Embodiments of the subject matter described in this specification can be implemented as one or more computer program products, i.e., one or more modules of computer program instructions encoded on a computer readable medium for execution by, or to control the operation of, data processing apparatus. The computer readable medium is a machine-readable storage device. The invention can be embodied in and/or or used with various apparatus, devices, and machines for processing data, including by way of example a programmable processor, a computer, or multiple processors or computers.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment.

Embodiments of the invention can be implemented in a computing system that includes a back end component, e.g., as a data server, or that includes a middleware component, e.g., an application server, or that includes a front end component, e.g., a client computer having a graphical user interface or a web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Other embodiments are within the scope of the following claims.

What is claimed is:

1. A computer-implemented method comprising:
recording, by one or more computers, a transfer of a proprietary right in debt assets from a first party type to a legal trust, the first party type being a lender of the debt assets to a second party type;
executing, by the one or more computers, a mathematical model to assess risks associated with the debt assets;
determining, based on the assessed risk, terms for issuance of an obligation granting the first party type a right to use assets in the legal trust as collateral for one or more transactions; and
recording, by the one or more computers, issuance of the obligation to the first party type, the obligation being issued in response to the transfer of the proprietary right in the debt assets.

2. The computer-implemented method of claim 1 wherein the transfer is one of a plurality of transfers from plural ones of the first party type and the method further comprises:
recording the plurality of transfers into corresponding plural accounts for the plural ones of the first party type.

3. The computer-implemented method of claim 2 wherein the debt assets are long term loans, short term loans and accounts receivables.

4. The computer-implemented method of claim 1, further comprising
recording, by the one or more computers, a guarantee by the first party type to margin the debt assets, with the margin being other types of financial assets that can include cash or securities.

5. The computer-implemented method of claim 1 wherein the proprietary right in the debt assets is acquired through a lending agreement.

6. The computer-implemented method of claim 4 wherein the obligation has a predetermined maturity date, and the method further comprises:
recording, by the one or more computers, a guarantee by the first party type to return the obligation or pay cash based on the value of the obligation on the predetermined maturity date.

7. The computer-implemented method of claim 1 wherein the proprietary right is legal title to the debt assets without a transfer of a right to collect interest from the second party.

8. The computer-implemented method of claim 7 further comprising:
recording, by the one or more computers, a guarantee by the first party type to buy the transferred debt assets back on a maturity date of the obligation.

9. The computer-implemented method of claim 1, wherein the proprietary right is transferred through transferring an entire ownership of the debt assets and the method further comprises:
transferring interest on the debt assets from the legal trust to the first party type with the interest being equal to the actual return on the debt assets plus an additional amount of interest on the obligation issued to the first party type tied to a generally accepted interest rate reference plus an additional interest amount.

10. The computer-implemented method of claim 9 further comprising:
recording, by the one or more computers, a guarantee by the first party type to buy the transferred debt assets back on a maturity date of the obligation.

11. The computer-implemented method of claim 7, wherein the first party type receives cash for transferring the debt assets and pays cash for buying the transferred debt assets back and the method further comprises:
recording, by the one or more computers, receipt of cash from the first party type in response to the issuance of the obligation.

12. The computer-implemented method of claim 1, wherein the debt assets further comprise an enhanced credit contract.

13. The computer-implemented method of claim 1, comprising recording, by the one or more computers a substitution of the debt assets with other debt assets from the first party type.

14. The computer-implemented method of claim 1 further comprising:
using debt assets provided by the legal trust as collateral for one or more transactions with a second party.

15. A computer program product tangibly stored on a computer readable storage device, the computer program product comprising instructions for causing a processor to:
record, by one or more computers, a transfer of a proprietary right in debt assets from a first party type to a legal trust, the first party type being a lender of the debt assets to a second party type;
execute, by the one or more computers, a mathematical model to assess risks associated with the debt assets;
determine, based on the assessed risk, terms for issuance of an obligation granting the first party type a right to use assets in the legal trust as collateral for one or more transactions; and
record, by the one or more computers, issuance of the obligation to the first party type, the obligation being issued in response to the transfer of the proprietary right in the debt assets.

16. The computer program product of claim 15 wherein the transfer is one of a plurality of transfers from plural ones of the first party type and the computer program product further comprises instructions to:
record the plurality of transfers into corresponding plural accounts for the plural ones of the first party type.

17. A system comprises:
one or more computer system, each system comprising:
a processor; and
memory coupled to the processor; and the computer system configured to:
record, by one or more computers, a transfer of a proprietary right in debt assets from a first party type to a legal trust, the first party type being a lender of the debt assets to a second party type;
execute, by the one or more computers, a mathematical model to assess risks associated with the debt assets;
determine, based on the assessed risk, terms for issuance of an obligation granting the first party type a right to use assets in the legal trust as collateral for one or more transactions; and
record, by the one or more computers, issuance of the obligation to the first party type, the obligation being issued in response to the transfer of the proprietary right in the debt assets.

18. The system of claim 17 wherein the transfer is one of a plurality of transfers from plural ones of the first party type and the system is further configured to:
record the plurality of transfers into corresponding plural accounts for the plural ones of the first party type.
